(19) United States
(12) Patent Application Publication
(10) Pub. No.: US 2010/0015362 A1
(43) Pub. Date: Jan. 21, 2010

(54) METHOD OF ELECTROLESS PLATING

(75) Inventors: Joo-Han LEE, Asan-si (KR); Dong-Chun LEE, Cheonan-si (KR); Yong-Hyun KIM, Suwon-si (KR); Seong-Chan Han, Cheonan-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/505,560

(22) Filed: Jul. 20, 2009

(30) Foreign Application Priority Data
Jul. 21, 2008 (KR) 10-2008-0070525

(51) Int. Cl. B05D 1/18

(52) U.S. Cl. 427/598

(57) ABSTRACT

An apparatus for electroless plating includes a plating bath containing an aqueous metal salt solution, and a magnetic field generator for generating a magnetic field. An object to be plated is immersed in the solution. The magnetic field generated by the magnetic field generator increases the level at which the metal ions are attracted to a surface of the object. Therefore, a layer of plating of good quality may be formed at a rapid rate.

### BACKGROUND

1. Technical Field

Example embodiments relate to the fabricating of components, electrodes and wiring patterns of semiconductor devices, PCBs, semiconductor packages and the like. More particularly example embodiments relate to an apparatus for electroless plating and to a method of electroless plating.

2. Description of the Related Art

Nowadays, the electronic information industry centers on the development of the high-density mounting of semiconductor devices, such as those used in cellular phones, personal data assistants (PDAs) and so on. An electrically and physically stable connection between minute pad electrodes of the semiconductor devices and wiring on a substrate is required to achieve the high-density mounting. A metal contact layer has been suggested to provide such an electrically and physically stable connection. The metal contact layer is a layer of gold, nickel or nickel-gold plated on the pad electrodes. In this respect, the metal contact layer must have a uniform thickness if the connection is to be strong and reliable. To this end, the metal contact layer is generally formed using electroless plating.

Electroless plating is a method of plating a base metal with a second metal using a solution of ions of the second metal. Unlike electrolytic plating which uses electric current to facilitate the plating process, electroless plating is facilitated using a reducing agent. Accordingly electroless plating does not require a power source (as does electrolytic plating) and hence, the circuitry of the semiconductor device is less likely to be damaged during the plating process.

However, the plating solution imposes limitations on the type of base metal that can be employed, and forming a metal layer having a sufficient thickness using electroless plating is relatively time consuming. In addition, the surface structure of the metal layer may be rough and the metal layer may include some surface defects. For example, when nickel is plated with gold using electroless plating, the surface of the nickel-gold layer is excessively rough and non-uniform because of the substitution reaction of nickel with gold. Accordingly, the bond between nickel-gold contact layers and other elements, such as solder balls, can be weak.

### SUMMARY

Example embodiments of the present invention provide an apparatus for electroless plating capable of rapidly plating an object.

Likewise, example embodiments of the present invention provide an electroless method of rapidly and uniformly plating an object.

Example embodiments of the present invention provide a method of manufacturing a ball grid array (BGA) printed circuit board (PCB) using electroless plating.

According one aspect of the present invention, there is provided an apparatus for electroless plating includes a plating bath and a magnetic field generator associated therewith. The plating bath contains an aqueous metal salt solution producing metal ions and in which an object to be plated is immersed. The magnetic field generated by the magnetic field generator causes the metal ions in the solution to concentrate at a surface of the immersed object. The magnetic field generator may be provided below the plating bath. Alternatively, the magnetic field generator may be disposed alongside the plating bath. The magnetic field generator may be a permanent magnet or an electromagnet.

In the case of a permanent magnet, the north pole of the magnet faces the plating bath when the magnet is disposed outside the bath. Alternatively, the apparatus may include a transporting arm having a chuck for seizing the object, and operable to immerse the object into the aqueous metal salt solution. In this case, the magnetic field generator is integrated with the transporting arm so that the magnetic field passes through the object seized by the chuck of the arm.

According to another aspect of the present invention, there is provided a method of electroless plating which uses a magnetic field. An object to be plated is immersed in an aqueous metal salt solution. A magnetic field is generated for inducing and metal ions in the aqueous metal salt solution to concentrate at a surface of the object, and accumulate. A plated layer is formed by facilitating a (reduction) reaction that causes the metal ions concentrated at the surface of the object under the influence of the magnetic field to be adsorbed.

According another aspect of the present invention, there is provided a method of manufacturing a BGA PCB in which an electrode pad of the PCB is electrolessly plated using a magnetic filed. First, a metal wiring structure including a wire bonding pad and a solder ball pad is formed on a substrate. Then, a resist pattern having an aperture exposing the solder ball pad is formed. The substrate having the exposed solder ball pad is immersed into a first aqueous metal salt solution. A magnetic field is generated for inducing metal ions in the first aqueous metal salt solution to concentrate at a surface of the solder ball pad. A (reduction) reaction is facilitated that cause metal ions, concentrated at the surface of the bonding pad under the influence of the magnetic field to be adsorbed. As a result, a first bonding layer is formed on the solder ball pad.

The first aqueous metal salt solution may be an aqueous nickel salt solution. Thus, the solder ball pad may be nickel-plated.

According to another aspect of the present invention, the method of manufacturing a BGA PCB may further include the following steps. The substrate having the first bonding layer is immersed into a second aqueous metal salt solution. A magnetic field may be generated to induce metal ions in the second aqueous metal salt solution to concentrate at a surface of the first bonding layer. A second bonding layer may be formed by facilitating a (reduction) reaction which causes the first bonding layer to adsorb metal ions concentrated at the surface thereof under the influence of the magnetic field. Preferably, the second aqueous salt solution is an aqueous gold salt solution such that the solder ball pad becomes nickel-gold plated.

### BRIEF DESCRIPTION OF THE DRAWINGS

Example embodiments may be more clearly understood from the following detailed description of the preferred embodiments, i.e., non-limiting examples, thereof made in conjunction with the accompanying drawings.

FIG. 1 is a cross-sectional view of an embodiment of an apparatus for electroless plating using a magnetic field;

FIG. 2 is a cross-sectional view of another embodiment of an apparatus for electroless plating using a magnetic field;

FIG. 3 is a cross-sectional view of still another embodiment of an apparatus for electroless plating using a magnetic field;

FIG. 4A is a SEM image of surface portions of a nickel-plated layer formed according to an embodiment of the present invention;

FIG. 4B is a SEM image of surface portions of a nickel-plated layer formed according to the related art;

FIGS. 5 to 9 are cross-sectional views of a semiconductor substrate and together illustrate a method of forming a metal contact layer on a source/drain region of a semiconductor device in accordance with example embodiments;

FIGS. 10 to 16 are cross-sectional views of a substrate structure and together illustrate a method of manufacturing metal contact layers of a BGA PCB in accordance with example embodiments; and

FIGS. 17 to 19 are cross-sectional views of semiconductor devices and together illustrate a method of manufacturing a semiconductor stack package in accordance with example embodiments.

### DETAILED DESCRIPTION OF THE EMBODIMENTS

This application claims priority under 35 U. S. C. §119 to Korean Patent Application No. 2008-70525, filed on Jul. 21, 2008 in the Korean Intellectual Property Office (KIPO), the contents of which are herein incorporated by reference in their entirety.

Various example embodiments will be described more fully hereinafter with reference to the accompanying drawings. In the drawings, the sizes and relative sizes of layers and regions may be exaggerated for clarity. Furthermore, like reference numerals designate like elements throughout the drawings.

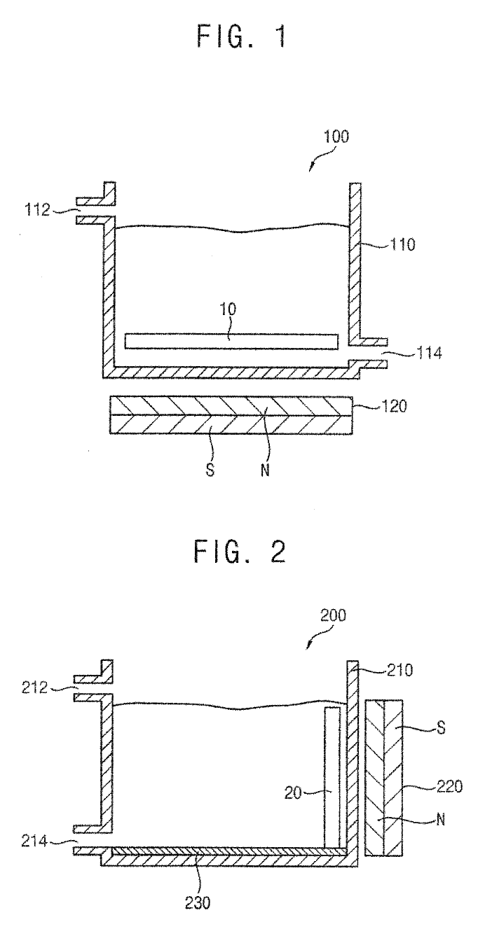

Referring to FIG. 1, an apparatus 100 for electroless plating includes a plating bath 110 which contains an aqueous metal salt solution (a source of metal ions) and in which an object 10 to be plated is immersed in the solution. The apparatus 100 also includes a magnetic field generator 120 for generating a magnetic field to force the metal ions onto the surface of the object to be plated. The magnetic field generator 120 may be a permanent magnet or an electromagnet.

The plating bath 110 has a bottom, first and second side portions and an open top. A supply line 112 is connected to one of the side of the plating bath 110 at the top thereof for introducing the aqueous metal salt solution into the bath. A drain line 114 is connected to the other of side of the bath at the bottom thereof for discharging a waste aqueous metal salt solution. The aqueous metal salt solution contained in the plating bath 110 may be an aqueous nickel (Ni) salt solution, an aqueous gold (Au) salt solution, an aqueous silver (Ag) salt solution, or an aqueous cobalt (Co) salt solution. Also, the aqueous metal salt solution includes a reducing agent. The object 10 to be plated may be a printed circuit board (PCB) or a semiconductor substrate. Additionally, a support (not shown) for supporting the object 10 may be provided within the plating bath 110.

The magnetic field generator 120 may be provided at the lower portion of the plating bath 110 into which the object 10 is inserted. For example, when the object 10 is immersed into the aqueous metal salt solution and is oriented parallel to the bottom of the plating bath 110, the magnetic field generator 120 may be provided below the plating bath 110 so that the object 10 is vertically aligned with the magnetic field generator 120. In this case, the magnetic field generator 120 generates a magnetic field whose field lines pass through the object 10 from the bottom to the top thereof to induce the metal ions to concentrate at the surface of the object 10. For instance, the magnetic field generator 120 may generate a magnetic field of such a polarity that metal cations are concentrated on the surface of the object 10. In this example, the north pole of the permanent magnet faces the bottom surface of the object 10 to be plated. In the case of an electromagnet, the orientation of the coil of the magnet and the direction in which current is supplied through the coil are such that the direction or polarity of the magnetic field produced is the same as that of a permanent magnet whose north pole is oriented as shown in the figures. Also, the magnetic field generated by the magnetic field generator 120 can reduce the activation energy, i.e., to thereby increase the rate of the reaction caused by the reducing agent.

A method of forming a layer on the object 10 using the apparatus 100 for electroless plating will be described in detail, hereinafter.

A nickel aqueous metal solution for electroless plating is supplied into the plating bath 110 through supply line 112. The object 10 is immersed in the aqueous nickel solution and is oriented (supported) so that the bottom of the object 10 faces the bottom of the plating bath 110. A north pole of the magnetic field generator 120 faces the object 10.

Therefore, a magnetic field generated by the magnetic field generator 120 passes through the aqueous nickel solution and the object 10. The magnetic field also reduces the activation energy so that the reducing agent may more readily cause the reduction reaction that facilitates the plating process. Nickel cations thus concentrate on the surface of the object 10, rapidly accumulate and are rapidly adsorbed into the surface of the object 10. Thus, a thin nickel film is rapidly formed on the object 10.

FIG. 2 illustrates another apparatus for electroless plating using a magnetic field in accordance with example embodiments.

Referring to FIG. 2, an apparatus 200 for electroless plating includes a plating bath 210 containing an aqueous metal salt solution and in which an object 20 to be plated is immersed. The apparatus 200 also includes a magnetic field generator 220 for generating a magnetic field which causes the metal ions to concentrate at the surface of the object 20. A supply line 212 is connected to (the top of) the plating bath 210 for supplying the aqueous metal salt solution into the bath, and a drain line 214 is connected to (the bottom of) the plating bath 210 for discharging a waste aqueous metal salt solution from the bath. A heater 230 is provided at the bottom of the plating bath 210. The plating bath 210, supply line 212, the discharging line 214, and the magnetic field generator 220 are similar to those illustrated in and described above with reference to FIG. 1.

However, in this embodiment, the magnetic field generator 220 is disposed at a side of the plating bath 210. Also, the object 20 is supported within the bath such that the bottom thereof faces the side of the plating bath 210, and the magnetic field generator 220 faces the bottom of the object 20. The magnetic field generator 220 is operative to generate a magnetic field that passes through the object 20, and which magnetic field has a polarity that acts to attract the metal ions onto the surface of the object 20. For example, in the case in which the magnetic field generator 220 is a permanent magnet, the north pole of the magnet faces the surface of the immersed object 20 to be plated, and thus the surface becomes charged so that metal cations are attracted to the surface of the object 20.

Additionally, the heater 230 heats the aqueous metal salt solution contained in the plating bath 210 to a higher temperature than room temperature, so that the activity of the metal ions in the aqueous metal salt solution is increased and hence, the electroless plating rate is increased. The heater 230 may include a resistive wire (not shown) and a heat plate (not shown).

Hereinafter, a method of forming a layer on the surface of the object 20 using the apparatus 200 for electroless plating will be described in detail.

An aqueous gold salt solution for electroless plating is supplied into the plating bath 210 through supply line 212. The aqueous gold salt solution contained in the plating bath 210 is heated above room temperature by the heater 230. Also, the object 20 is immersed in the aqueous gold salt solution with the bottom thereof facing the side of the plating bath 210 where the magnetic field generator 220 is disposed outside the bath.

A magnetic field generated by the magnetic field generator 220 charges the surface of the object 20 and reduces the activation energy that must be overcome in order for the reducing agent to cause the reduction reaction that facilitates the plating process. As a result, a concentration of cations, i.e., gold ions, accumulate on the surface of the object 20 and are adsorbed by the surface of the object 20. Thus, a plated layer, i.e., a thin gold film, is formed on the object 20.

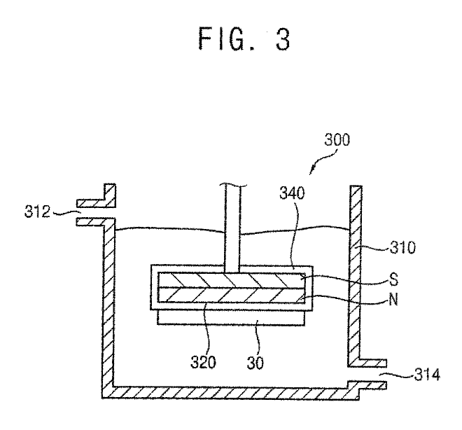

FIG. 3 illustrates yet another apparatus for electroless plating using a magnetic field in accordance with example embodiments.

Referring to FIG. 3, an apparatus 300 for electroless plating includes a plating bath 310 containing an aqueous metal salt solution in which an object 30 to be plated is immersed. The apparatus 300 also includes a magnetic field generator 320 for generating a magnetic field which causes metal ions in the solution to concentrate at the surface of the object 30, and a transporting arm 340 for holding the object 30 and immersing the object 30 in the aqueous metal salt solution. A supply line 312 is connected to the upper portion of the plating bath 310 for supplying the aqueous metal salt solution into the bath. A drain line 314 is connected to a lower portion of the plating bath 310 for discharging a waste metal salt solution from the bath. The plating bath 310 and the magnetic field generator 320 are similar to those illustrated in and described with reference to FIG. 1.

The transporting arm 340 is operable to seize the object 30 by its bottom and/or side portions, and to move up and down to immerse the object 30 in the aqueous metal salt solution in the plating bath 310. The magnetic field generator 320 may be integrated with the transporting arm 340. In particular, the transporting arm 340 includes a chuck by which one side of the object 30 can be grasped when the object 30 is immersed in the aqueous metal salt solution, and the magnetic field generator 320 is affixed to the transporting arm 340 such that the magnetic field generator 320 face the side of the object 30 grasped by the chuck. In this case, the magnetic field generator 320 generates a magnetic field which passes through the object 30. In the case in which the magnetic field generator 320 is a permanent magnet, the north pole of the faces the object 30 immersed in the plating bath 310. As a result, cations, i.e., metal ions, in the solution concentrate at the surface of the object 30.

Hereinafter, a method of forming a layer on a surface of the object 30 using the apparatus 300 will be illustrated.

An aqueous silver metal salt solution for electroless plating is supplied into the plating bath 310 through supply line 312. The transporting arm 340 seizes the object 30, and positions the object 30 so that it is immersed in the aqueous silver salt solution contained in the plating bath 310. The magnetic field generator 320 generates a magnetic field to charge the surface of the object 30 and to reduce the activation energy that must be overcome by the reducing agent in the aqueous silver salt solution. As a result, the cations, i.e., the silver ions, become concentrated at the surface of the object 30, accumulated and are adsorbed into the surface of the object 30. Thus, a thin silver film is formed on the object 30.

According to the embodiments described above, a concentration of metal ions is formed on a surface of an object to be plated using a magnetic field. Therefore, a plated layer may be formed fast.

### Evaluation of the Forming of a Nickel-Plated Layer

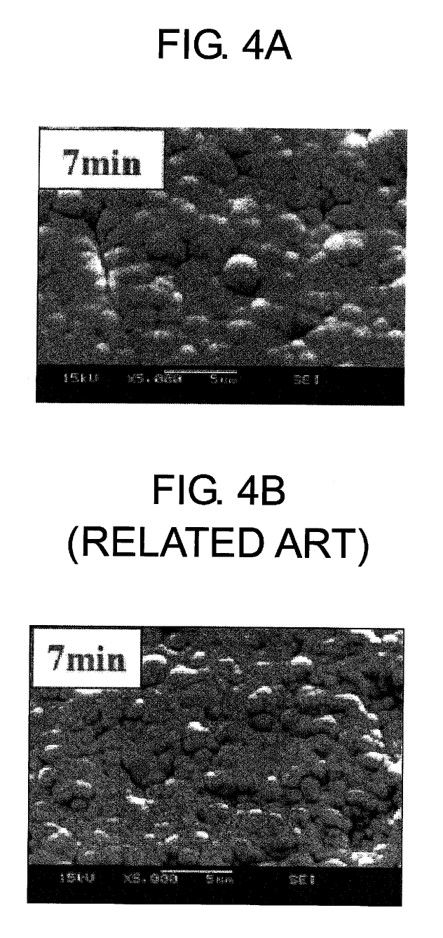

Characteristics of nickel-plated layers formed by electroless plating methods were evaluated. More particularly, a first nickel-plated layer A was formed by applying a magnetic field to an object immersed in an aqueous solution of nickel for about 7 minutes using the apparatus 100. A second nickel-plated layer B was formed using a conventional apparatus for about 7 minutes (i.e., by immersing an object in an aqueous solution of nickel without applying a magnetic field). The surfaces of the first and second nickel-plated layers A and B were inspected using a scanning electron microscope (SEM). The results are illustrated in FIGS. 4A and 4B, respectively.

Referring to FIGS. 4A and 4B, the sizes of the particles of the first nickel-plated layer A is about two or more times larger than those of the second nickel-plated layer B. That is, the example embodiment can achieve a deposition rate at least twice that of a corresponding but conventional electroless plating process.

FIGS. 5 to 9 illustrate a method of forming a metal contact layer in accordance with example embodiments. In this method, the metal contact layer may be an ohmic layer.

Referring to FIG. 5, an insulation patterned layer 430 having an opening 432 exposing a conductive pattern of a transistor is formed on a substrate 400. The substrate 400 may comprise silicon and the transistor may include a gate oxide layer 402, a gate electrode 406 and an impurity region 410. The gate electrode 406 may comprise doped polysilicon. The impurity region 410 serves as a source/drain region of the transistor. The transistor may also include gate spacers 408 on the sidewalls of the gate electrode 406.

The insulation patterned layer 430 may be formed by first forming an insulation layer, e.g., a silicon oxide layer, on the substrate 400 using a spin-coating process or a chemical vapor deposition (CVD) process. The insulation layer may then be planarized so as to have a planar upper surface. Next, an etching mask is formed on the insulation layer and a dry etching process is performed to remove a portion of the insulation layer exposed by the etching mask. As a result, the opening 432 is formed.

The conductive pattern exposed by the opening 232 may be the source/drain region 410 or the gate electrode 406. In the present embodiment, the source/drain region 410 is exposed by the opening 232. In the case in which the conductive pattern exposed by the opening 232 is to be the source/drain region 410, a portion of the source/drain region 410 may be etched along with the insulation layer, i.e., during the above-mentioned process in which the opening 432 is formed.

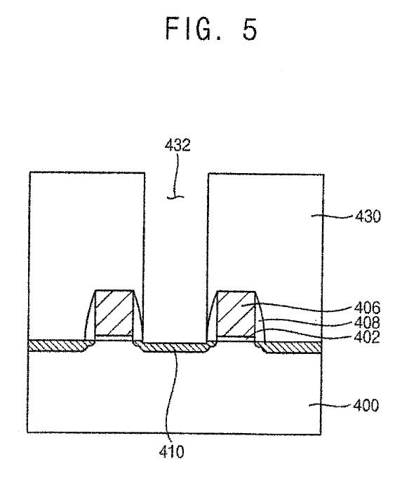

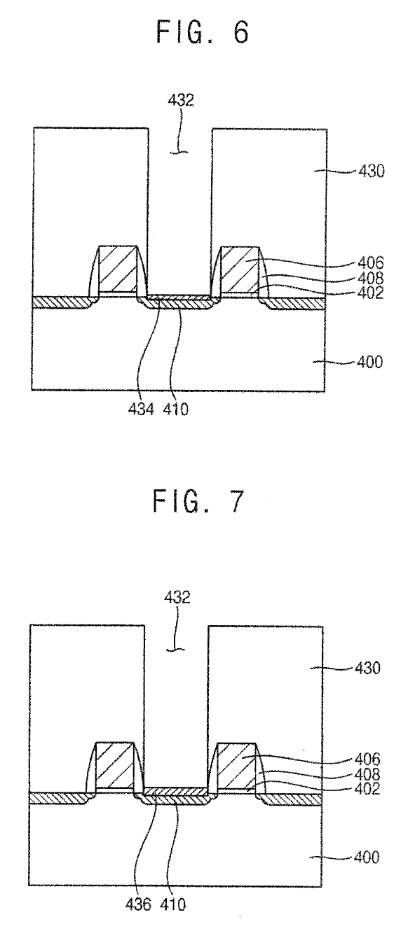

Referring to FIG. 6, a transition metal layer 434 may be formed on the exposed surface of the source/drain region 410. The transition metal layer 434 may include a tungsten thin film, a titanium thin film, a nickel thin film, or a cobalt thin film. In the present embodiment, the transition metal layer 434 is a cobalt thin film.

The cobalt thin film 434 may be formed using one of the apparatuses 100, 200 and 300. For example, the substrate 400 is immersed into an aqueous cobalt salt solution including a reducing agent such as formaldehyde or hydrazine. A magnetic field is generated to concentrate the cobalt ions at the surface of the source/drain region 410 exposed by the opening 432. The cobalt ions concentrated at the surface of the source/drain region 410 by the magnetic field are then rapidly deposited on the source/drain region 410 as cobalt molecules. However, the cobalt molecules will not be deposited on the silicon oxide layer 430 due to the chemistry behind the electroless plating process. As a result, a cobalt layer is formed only on the exposed surface of the source/drain region 410.

Referring to FIG. 7, the cobalt layer 434 reacts with the silicon (Si) in the source/drain region 410 to form a cobalt silicide layer 436.

In one example embodiment, the cobalt silicide layer 436 is formed by a single silicidation process at a temperature of about 400° C. to 900° C. In another example, the cobalt silicide layer 436 is formed by a two-step silicidation process. In this example, the substrate 400 including the cobalt layer is thermally treated at a temperature of about 400° C. to 500° C. to form a preliminary cobalt silicide (CoSi) layer. Then, the preliminary cobalt silicide layer is thermally treated at a temperature of about 700° C. to 900° C. to produce the cobalt silicide layer (CoSi₂) 436.

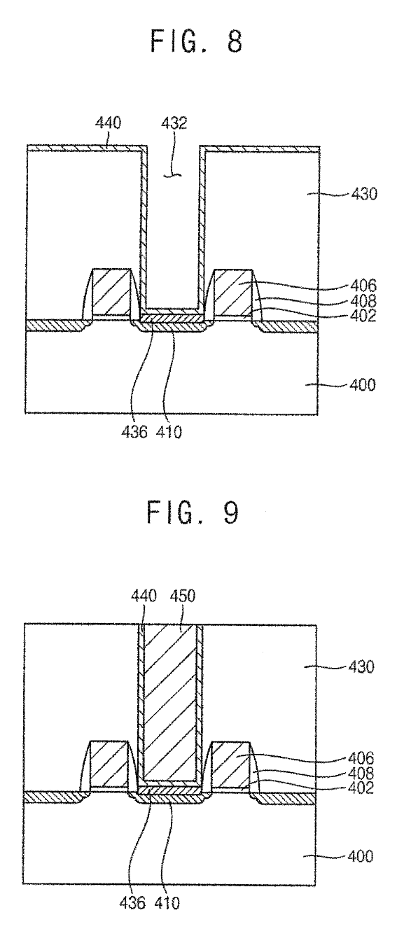

Referring to FIG. 8, a conductive layer 440 including tungsten and having a substantially uniform thickness is formed on the silicon oxide layer 430, the cobalt silicide layer 436 and along the sides of the opening 432. The conductive layer 440 may be a tungsten nitride layer, a tungsten layer or a tungsten/tungsten nitride layer.

Referring to FIG. 9, a metal plug 450 is formed to fill the opening 432. More particularly, a metal layer is formed on the conductive layer 440 to such a thickness as to cover the silicon oxide layer 430 and fill the opening 432. The metal layer may be a tantalum (Ta) layer, a copper (Cu) layer, a tungsten (W) layer, a titanium (Ti) layer, or an aluminum (Al) layer. The metal layer may be formed by a CVD process or a physical vapor deposition (PVD) process such as a sputtering process. In the present embodiment, the metal layer is a tungsten layer. Then, a chemical mechanical polishing (CMP) process is performed on the tungsten layer until the silicon oxide layer 430 is exposed. As a result, the tungsten plug 450, which is electrically connected to the source/drain region 410, is formed.

FIGS. 10 to 16 illustrate a method of manufacturing a BGA PCB in accordance with example embodiments.

Referring to FIG. 10, a copper clad laminate (CCL) substrate 500 is formed by coating both surfaces of an insulating resin substrate 501 with a copper thin film 502. The CCL substrate 500 may be a glass/epoxy CCL substrate, a heat-resistant resin CCL substrate, a paper/phenol CCL substrate, a high frequency CCL substrate, a flexible CCL substrate (polyimide film) or a composite CCL substrate. In the present embodiment, a glass/epoxy CCL substrate is used to manufacture a double-sided PCB and a multi-layered PCB.

As illustrated in FIG. 11, a first opening A is formed. The first opening A may be formed using a drill so that the opening A may be perpendicular to top and bottom surfaces of the CCL substrate 500. Particles, dust, fingerprints, etc. may be produced during the forming of the first opening A. Therefore, a cleaning process may be implemented to remove the particles, dust, fingerprints, etc. from the copper thin film 502 and from the interior wall of the substrate which defines the sides of the first opening A.

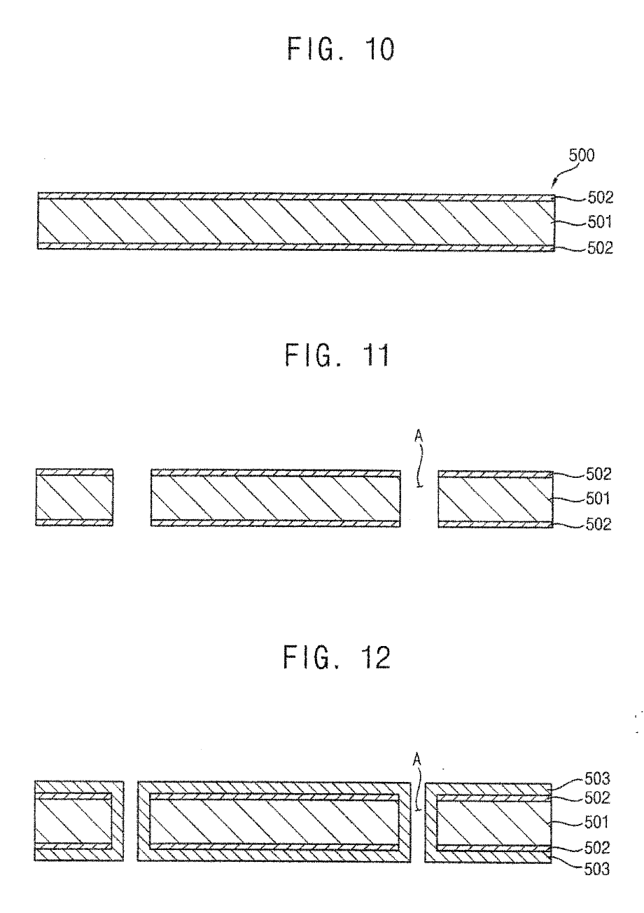

Referring to FIG. 12, a plating process is performed to form a copper-plated layer 503 on a surface of the CCL substrate 500. The copper-plated layer 503 may be formed by an electroless copper plating process and a copper electroplating process. The electroless plating process may be performed prior to the copper electroplating process so that a layer of the desired material may be formed on the insulating resin substrate 501 including the electrically insulative material. In this respect, the electroless copper plating process serves as a pre-treatment process in which a seed layer for the copper electroplating process is formed. Any of the apparatus described above with reference to FIGS. 1 to 3 may be used to carry out the electroless plating process.

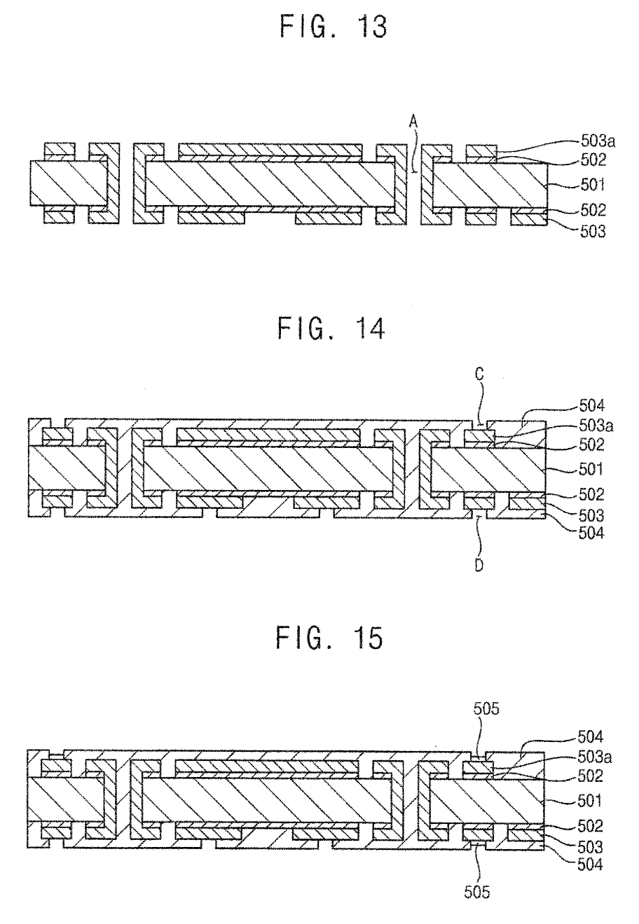

Referring to FIG. 13, a photoresist pattern (not shown) is formed on the copper-plated layer 503. The copper-plated layer 503 is etched using the photoresist pattern as a mask to form a wiring pattern 503a including a circuit pattern, a wire bonding pad and a solder ball pad.

Referring to FIG. 14, a solder resist pattern 504 having openings therein is formed on the wiring pattern 503a and the insulating resin substrate 501 as follows. A solder resist is applied to the surface of the CCL substrate 500 and dried to produce a solder resist layer. Prior to this, though, a cleaning process or a surface etching process may be performed on the CCL substrate 500 having the wiring pattern 503a. Such a cleaning process serves as a pre-treatment process to remove fingerprints, oil, and dust. A surface etching process serves as a pre-treatment process that reduces the roughness of the CCL substrate 500 to improve the adhesion of the solder resist to the CCL substrate 500. The solder resist layer is then exposed and developed to form the solder resist pattern 504. The openings in the solder resist pattern 504 include an opening C exposing the wire bonding pad of the wiring pattern 503a and an opening D exposing the solder ball pad of the wiring pattern 503a.

Referring to FIG. 15, a nickel layer or a nickel-gold layer 505 is formed as a bonding layer (electroless nickel/immersion gold (ENIG) pad) on the wire bonding pad exposed through the second opening C and on the solder ball pad exposed through the third opening D. The nickel layer or nickel-gold layer 505 may be formed by an electroplating process or an electroless plating process. In the present embodiment the nickel layer or nickel-gold layer 505 is formed by an electroless plating process using one of the apparatus illustrated with reference to FIGS. 1 to 3.

In a specific example, the exposed surface of the pad to be plates is pre-treated to have a roughness (Ra) of about 0.5 μm≦Ra≦2.0 μm, preferably about 0.5 μm≦Ra≦1.5 μm, and more preferably about 0.5 μm≦Ra≦1.0 μm. The pre-treatment to reduce the surface roughness will enhance the ability of the nickel-gold-plated layer to bond to the pad.

After the pre-treatment, the CCL substrate 500 is immersed into an aqueous nickel salt solution, and the CCL substrate 500 is charged using the magnetic field generated by an electroless plating apparatus of the example embodiment. The cations, i.e., the nickel ions, are thus concentrated on the surface of the exposed bonding pad and the exposed solder ball pad, accumulate and are adsorbed onto the pads to form a nickel layer. Then the CCL substrate 500 having the nickel layer thereon is immersed into an aqueous gold salt solution, and charged using a magnetic field again. Accordingly, the cations, i.e., the gold ions, concentrate on the surface of the exposed nickel layer, accumulate and are adsorbed to form a gold layer. As a result, nickel-gold layer 505 is formed on the bonding pad and on the solder ball pad.

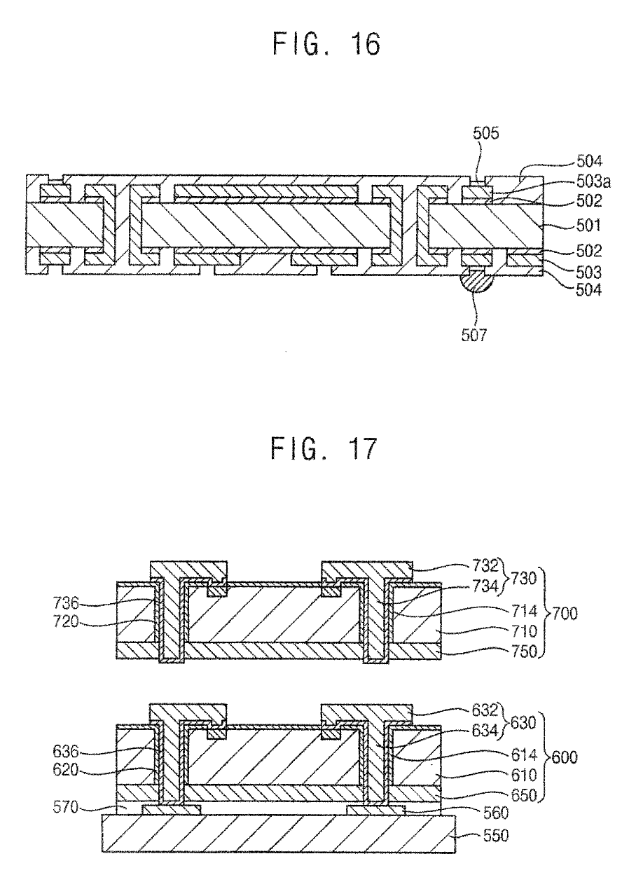

Referring to FIG. 16, a solder ball 507 is formed on the solder ball pad on which the nickel-gold layer 505 is formed. Thus, a BGA PCB is fabricated.

In a conventional plating process which does not employ a magnetic field, forming a nickel-gold layer of a thickness of about 12 μm, necessary to achieve a high strength bond with the layer being plated, requires a long amount of time or the plating bath must maintained at a high temperature. However, the long processing time or high temperature required may allow for/cause the plating to be eluted by the solder resist or may result in overplating. In the electroless plating method in accordance with example embodiments, the plating can be formed very fast, e.g., at least twice as fast as the conventional method. Therefore, the above-described problems are not created and sufficient solder bond strength may be obtained.

FIGS. 17 to 19 illustrate a method of manufacturing a semiconductor stack package in accordance with example embodiments.

Referring to FIG. 17, a first semiconductor package 600 includes a semiconductor pattern 610 having an opening 614 therethrough, an insulation layer 620 covering the semiconductor pattern 610 including the walls thereof that defines the sides of the opening 614, a wiring structure 630 electrically connected to a contact pad of a semiconductor device of the package and a polymer insulation member 650 provided on a bottom of the semiconductor pattern 610. The contact pad may be a plated layer made by an electroless plating method using a magnetic field according to example embodiments. The wiring structure 630 has a wiring pattern 632 including a plated layer formed by an electroless plating method according to example embodiments, and a plug 634. The semiconductor pattern 610 is the base or substrate of a semiconductor chip. The bottom of a plug 634 of the first semiconductor package 600 is mounted on an electrode pad 560 of a PCB 550. The first semiconductor package 600 and the PCB 550 may be fully adhered to each other via a first filling material 570.

A second semiconductor package 700 may include substantially the same configuration and components as the first semiconductor package 600. That is, the second semiconductor package 700 may include a semiconductor pattern 710 having an opening 714 therethrough, an insulation layer 720 covering the semiconductor pattern 710, a wiring structure 730 electrically connected to a contact pad of a semiconductor device of the package, and a polymer insulation member 750 provided on the bottom of the second semiconductor pattern 710.

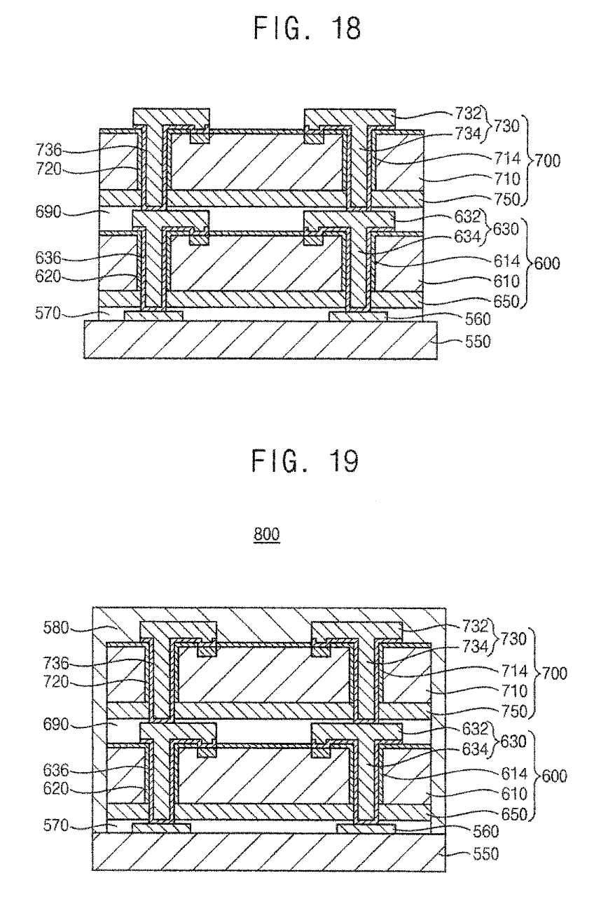

Referring to FIG. 18, the bottom of the plug 734 of the second semiconductor package 700 is mounted on the wiring pattern 632 of the first semiconductor package 600.

A conductive filling material 690 may be injected into the space between the first and second semiconductor packages 600 and 700 so that the first and second semiconductor packages 600 and 700 are more firmly adhered to each other.

Referring to FIG. 19, a molding compound 580 is formed around the first semiconductor package 600 and the second semiconductor package 700 to form a semiconductor stack package 800.

According to example embodiments described above, metal ions in an aqueous metal salt solution are concentrated on an object to be plated using a magnetic field, and the activation energy that must be overcome by a reducing agent in the aqueous solution is reduced. Accordingly, a metal layer can be rapidly deposited on the object, and the surface roughness can be reduced. Furthermore, the thickness of the plating and the amount of the active metal ions may be controlled, and thus the plating may be formed on the object very fast.

Finally, although the example embodiments have been described with reference to the preferred embodiments thereof, the present invention may be embodied in other ways. Therefore, it is to be understood that the foregoing description is illustrative of the present invention and that the present invention is not limited to the specific embodiments disclosed. Rather, other embodiments and modifications of the disclosed embodiments may fall within the true spirit and scope of the invention as defined by the appended claims.

1-6. (canceled)

7. A method of electroless plating, comprising:
immersing an object to be plated into an aqueous metal salt solution;
generating a magnetic field that induces metal ions in the aqueous metal salt solution to concentrate at a surface of the object; and
facilitating a reaction that causes the surface of the object to adsorb the metal ions.

8. The method of claim 7, wherein the magnetic field lines of the magnetic field pass from a lower portion of the object to an upper portion of the object.

9. The method of claim 7, wherein the aqueous metal salt solution is an aqueous nickel salt solution or an aqueous gold salt solution.

10. The method of claim 7, wherein the object is a printed circuit board (PCB) including a solder ball pad.

11-14. (canceled)

15. The method of claim 7, further comprising heating the aqueous metal salt solution.
